(19) United States
(12) Patent Application Publication
(10) Pub. No.: US 2020/0233417 A1
(43) Pub. Date: Jul. 23, 2020

(54) ANALYZING RECURRENT STREAMS OF DIGITAL DATA TO DETECT AN ANOMALY

(71) Applicant: AIRBUS, BLAGNAC (FR)

(72) Inventors: NICOLAS BOURDIS, PUTEAUX (FR); DENIS MARRAUD, ISSY LES MOULINEAUX (FR)

(21) Appl. No.: 16/714,708

(22) Filed: Dec. 14, 2019

Related U.S. Application Data
(63) Continuation of application No. 14/758,224, filed on Jun. 26, 2015.

(30) Foreign Application Priority Data
Dec. 31, 2012 (FR) 12 63000

(51) Int. Cl. G05D 1/00; G06N 5/02; G06N 7/00; G06F 16/29; G06K 9/00; B64C 39/02

(52) U.S. Cl. CPC G05D 1/0094; G06N 5/02; G06N 7/005; B64C 2201/127; G06K 9/0063; B64C 39/024; G06F 16/29

(57) ABSTRACT

A method for analyzing recurrent streams of digital data to detect anomalies. The digital data streams are acquired by an explorer having a sensor and processed by a digital data processing center. A knowledge base and a statistical model representing a set of the digital data having same context of obtainment are generated from the stream of digital data acquired by the sensor. Another stream of digital data is acquired by the sensor and the digital data processing center detects anomalies by comparing the statistical model to the statistical data of the other stream of digital data.

### TECHNICAL FIELD OF THE INVENTION

The invention belongs to the field of the processing of digital data and relates particularly to a method for analyzing recurrent streams of digital data to detect anomalies.

### BACKGROUND OF THE INVENTION

According to the prior art, a method for analyzing digital data, such as images or videos, is used to assist an operator to interpret the digital data. The digital data correspond to geographical regions and arise from sensors positioned on observation platforms such as drones, airplanes, helicopters or satellites observing the geographical regions.

The method makes it possible to detect on the basis of the digital data an area of interest, that is to say a part of a geographical region having an unusual appearance. For this purpose, the method comprises a learning phase during which a knowledge base grouping together the digital data is created and a step of detecting areas of interest.

In numerous operational cases, an observation platform performs frequent and recurrent observations of one and the same geographical region. This repeated observation implies that a significant digital volume of data is generated by the observation platform. This significant digital volume of data makes it possible to precisely ascertain each geographical region. However, this significant volume of data renders the interpretation of the data difficult. Indeed, a search for a data in such a volume of data is not efficient and the viewing of the volume of data is not easy.

### OBJECT AND SUMMARY OF THE INVENTION

The aim of the invention is notably to solve all or some of the above-mentioned problems.

To this end, the invention relates to a method for analyzing multiple geographical regions and for detecting anomalies or areas of interest by an explorer comprising a sensor and a center for processing digital data, which method comprises a first phase of learning the intrinsic appearance of each geographical region, in which a knowledge base comprising groups of digital data is built, followed by a second phase of detecting anomalies or areas of interest in the geographical regions, the phases comprising the steps consisting in:
a. acquiring a stream digital data corresponding to a geographical region by a sensor,
b. transmitting the stream of digital data acquired in step a) to the digital data processing center;
c. processing the stream of digital data transmitted in step b) by the digital data processing center.

The invention is advantageously implemented according to the embodiments set forth hereinafter, which are to be considered individually or according to any technically operative combination.

Advantageously, step c) comprises the steps consisting in:
d. recording the stream digital data transmitted in step b),
e. determining the context of obtainment of the digital data stream recorded in step d),
f. classing the digital data stream recorded in step d) into a group of digital data of the knowledge base having the same context of obtainment as the context of obtainment determined in step e), the set of digital data of the group of digital data being represented by a statistical model,
g. determining statistical data on the digital data stream recorded in step d),
h. determining the degree of compatibility between the statistical data determined in step g) and statistical data of the statistical model representing the group of digital data of step f),
i. comparing the degree of compatibility determined in step h) with a predefined threshold,

the first phase of learning the intrinsic appearance of each geographical region furthermore comprising the step consisting in:
j. updating the statistical model representing the group of digital data of step f) by virtue of the statistical data determined in step g),

the second phase of detecting anomalies or areas of interest in the geographical regions furthermore comprising the step consisting in:
k. determining a degree of difference between the statistical data and the statistical model of the data group determined in step j)
l. generating an alert if the degree of difference between the statistical data of the recorded digital data stream and the statistical model determined in step j) is greater than a predefined threshold, the alert indicating the detection of an anomaly or area of interest.

Thus, the interpretation of the digital data is facilitated by virtue of the statistical model. The updating of the statistical model allows the statistical model to be improved and to adapt to possible normal changes of the geographical region associated with the statistical model.

Advantageously, the method comprises, on completion of step i), a step consisting in:
m. harmonizing compliance of the digital data stream recorded in step d) with the digital data of the group of digital data of step f).

Thus, the compliance harmonization of the data makes it possible to utilize a larger number of data efficiently.

Advantageously, if the degree of compliance determined in step h) is less than the predefined threshold, step 1) comprises the sub-steps consisting in:
mi. generating an alert indicating that a compliance harmonization the group of digital data of step f) is not possible,
mii. manually harmonizing compliance of the digital data stream recorded in step d) with the digital data of the group of digital data of step f),
miii. automatically harmonizing compliance of the group of digital data of step f).

Thus, the updating of the statistical model is optimized by virtue of the intervention of an operator.

Advantageously, the context of obtainment determined in step e) comprises:
the nature of digital data stream,
the geographical region corresponding to the digital data stream,
the viewpoint of the sensor that recorded the digital data stream,
the range of resolution of the digital data stream.

Thus, the knowledge base comprises several levels of indexation and utilization which facilitate the search for and the viewing of the digital data. Moreover, the knowledge base is multimodal, the knowledge base comprising several types of data originating from different sensors.

Advantageously, the method comprises after step 1) the step consisting in:
n. evaluating the relevance of the alert generated in step k).

Thus, an operator can specialize the method as a function of what interests the operator.

Advantageously, the explorer is included in a set comprising a drone, a helicopter, a balloon, an airplane and a satellite.

Advantageously, the sensor is included in a set comprising a camera, a photographic apparatus and a radar.

Advantageously, the center for processing the digital data is remote from the explorer.

Advantageously, the center for processing the digital data comprises a processor, a display and an input device.

### BRIEF DESCRIPTION OF THE DRAWINGS

The invention will be better understood on reading the following description, given by way of wholly non-limiting example, while referring to the figures which represent:

FIG. 1: a functional chart showing various steps of a phase of learning the intrinsic appearance of each geographical region of the method according to an exemplary embodiment of the invention;

FIG. 2: a functional chart showing various steps of a phase of detecting anomalies or areas of interest in the geographical regions of the method according to an exemplary embodiment of the invention; and

FIG. 3: a schematic representation of geographical regions, of an explorer and a digital data processing center according to an exemplary embodiment of the invention.

### DETAILED DESCRIPTION OF THE EMBODIMENTS

In these figures, references which are identical from one figure to another designate identical or analogous elements. For the sake of clarity, the elements represented are not to scale, unless stated to the contrary.

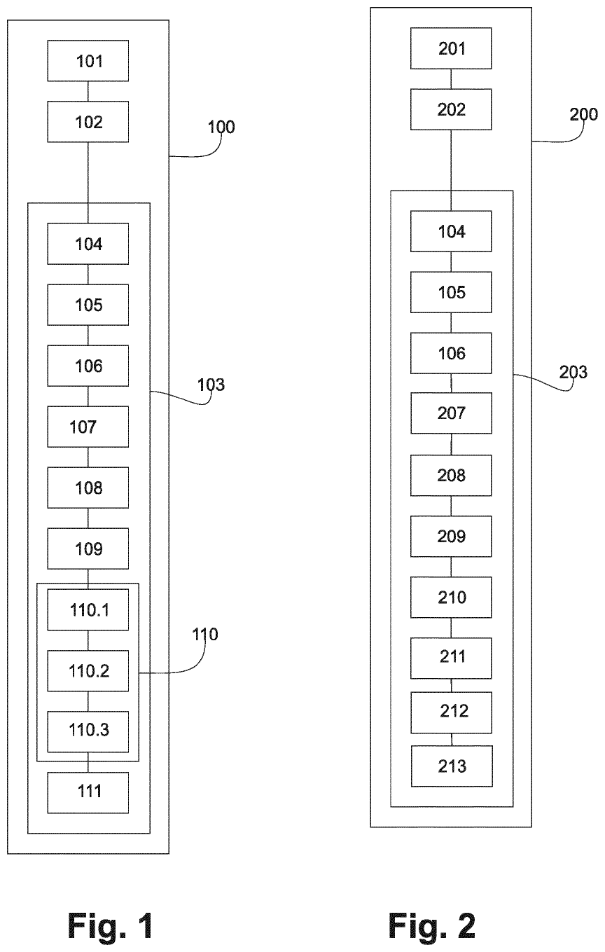

FIG. 1 shows the various steps of the method for analyzing geographical regions 300 and for detecting anomalies or areas of interest 301 by an explorer 310 comprising a sensor 311, and a digital data processing center 312. The method aids an operator to interpret digital data. More precisely, the method alerts the operator when it detects, by analyzing streams of recurrent digital data an anomaly or area of interest 301 in a geographical region 300.

An anomaly or area of interest 301 is here a part of a geographical region 300 having an unusual appearance. For example, the occurrence of an object in a usually deserted geographical region 300 defines an anomaly or area of interest 301.

The method comprises two phases 100 and 200. The first phase 100 is a phase 100 of learning the intrinsic appearance of each geographical region 300. The second phase 200 is a phase 200 of detecting anomalies or areas of interest 301 in the geographical regions 300.

A knowledge base 313 is built during the first phase 100, the knowledge base 313 comprising several groups of digital data. For this purpose, the first phase 100 comprises a step 101, in which the sensor 311 acquires a streams digital data corresponding to a geographical region 300 by the sensor 311. The sensor 311 is for example a camera, a photographic apparatus, or a radar. The explorer 310 is an observation platform such as a drone, a helicopter, a balloon, an airplane, a satellite or a terrestrial observation platform without this list being exhaustive.

The first phase 100 thereafter comprises a step 102 of transmitting the streams of digital data acquired in step 101 to the digital data processing center 312.

In FIG. 3, according to an exemplary embodiment, the digital data processing center 312 is remote from the explorer 310. As a variant, the digital data processing center 312 is included in the explorer 310. The center for processing the digital data 312 comprises the knowledge base 313, a processor 314, a display 315 and input device 316.

Returning to FIG. 1, the transmission step 102 is followed by a step 103 of processing the digital data stream transmitted in step 102 by the digital data processing center 312. This processing step 103 comprises seven steps 104-110.

More precisely, in step 104, the digital data processing center 312 records the digital data stream transmitted in step 102.

In a step 105, the digital data processing center 312 determines the context of obtainment of the digital data stream recorded in step 104 of recording a digital data stream. The context of obtainment of the digital data stream comprises the nature of the digital data stream, the geographical region 300 corresponding to the digital data stream, the viewpoint of the sensor 311 that recorded the digital data stream and the range of resolution of the digital data stream. The nature of the digital data stream depends on the sensor 311 used for the acquisition of the digital data stream. In an example, the data stream is a mapping, a data stream of a geographical information system, a radar image, an infrared image, an image in the visible domain. Data of the same nature may be of different type. Thus, an infrared sensor is able to deliver a data stream of video type or of still image type. Data of different type but of the same nature are able to be fused and are the to be reconcilable. On the other hand, data of different natures are not reconcilable.

The first phase comprises, after step 105 of determining the context of obtainment, a step 106 of classifying the digital data stream recorded in step 104 as a function of the context of obtainment of the digital data stream. This digital data stream is then classed in one of the groups of digital data of the knowledge base 313, the group having the same context of obtainment as the context of obtainment of the digital data stream, that is to say the same nature of digital data stream, the same geographical region 300, the same viewpoint of the sensor 311 and the same range of resolution. The group of digital data is represented by a statistical model. The statistical model is created on the basis of a reference data stream. In an example, the reference data stream is an ortho-image, a digital terrain model, a digital elevation model or a three-dimensional model. The term “ortho-image” here designates images of the terrestrial surface.

The knowledge base 313 thus comprises several levels of indexation and utilization. In an example a first level relates to the nature of the digital data stream, a second level relates to the geographical region 300 corresponding to the digital data stream, a third level relates to the viewpoint of the sensor 311 that recorded the digital data stream and a fourth level relates to the range of resolution of the digital data stream.

The knowledge base 313 is multimodal, the knowledge base 313 comprising several natures of data originating from different sensors 311. Moreover, one and the same geographical region 300 is represented by various natures of digital data, various viewpoints and various resolutions. Furthermore, the knowledge base 313 is multi-localized. In an example, a first digital data stream corresponds to a first geographical region 300 and a first viewpoint, a second digital data stream corresponds to the first geographical region 300 and a second viewpoint and a third digital data stream corresponds to a second geographical region 300 and to the first viewpoint.

In a step 107, the processor 314 of the digital data processing center 312 determines statistical data on the digital data stream recorded in step 104. If the digital data stream is an image in the visible domain, the statistical data are for example the global standard deviation of the image and the global average of the image. In an example, when the digital data stream is an image in the visible domain, the determination of the statistical data is performed on the basis of the gray level of the image when the image is in black and white, or on the basis of the red, green and blue levels of the image when the image is in color, or else on the basis of a displacement field calculated on the basis of the image.

When it is recorded, the digital data stream is firstly harmonized in compliance with the data of its group of reconcilable digital data. To this end, the degree of compatibility between the statistical data extracted from the recorded digital data stream and the statistical model representing its group of reconcilable digital data is determined (step 108).

This degree of compatibility is compared with a threshold, in the course of a comparison step 109.

If the degree of compatibility is greater than this threshold, then the recorded digital data stream greatly resembles those of the group of reconcilable digital data, and the system can readily perform the compliance harmonization in an automatic manner according to a step 110.3.

In the converse case, the recorded digital data stream is more difficult to process automatically, and the system requires the intervention of the operator. An alert is raised (step 110.1) to signal to the user that their intervention is required. The system determines a procedure ensuring a minimum intervention effort on the part of the operator, while guaranteeing that the system will thereafter be able to perform the compliance harmonization.

The compliance harmonization the incriminated data or data stream is then carried out manually by the operator in the course of a preparatory step 110.2. By way of example, if the digital data stream is an image in the visible domain, the operator performs a registration, that is to say associates a first point of the image with a first point of a first image of the associated group of data, and then a second point of the image with a second point of the first image of the associated group of data and so on and so forth for a minimum number of points.

The carrying out of this preparatory step then allows the system to terminate the compliance harmonization in an automatic manner 110.3.

The compliance harmonization thereafter allows the automatic updating of the statistical model.

During the learning phase, after the step of compliance harmonization 110, the recorded digital data stream is integrated into its group of reconcilable digital data. Two cases are possible depending on whether or not the group was empty before this integration.

If the group was empty before the integration of the recorded digital data stream, then it is necessary to create the multi-localized statistical model representing the group. Accordingly, use is made of a reference data or data stream (plane at a given altitude, digital terrain model, digital elevation model, 3D model, etc.) modeling the relief of the region considered. This reference data stream of the relief is combined with the statistical data of the recorded digital data stream so as to initialize the multi-localized statistical model representing the group of reconcilable digital data.

If the group was not empty, then the multi-localized statistical model representing the group of reconcilable digital data is updated 111 so that it takes into account the integration of the recorded digital data stream. Accordingly, the multi-localized statistical model is modified so that it represents the new group of reconcilable digital data (including the recorded digital data stream), by an incremental mechanism which does not make it necessary for the digital data already present in the group to be processed again.

The statistical model used is multi-localized, this signifying that it locally models the intrinsic appearance at multiple points of the observed geographical region. For example, on a satellite image of an airport, it is possible to simultaneously observe the various existing runways, the control tower, the parking lots, the access pathways for the users, etc. By combining a series of observations, it is therefore possible to locally model the intrinsic appearance of the various runways, the intrinsic appearance of the control tower, etc. A statistical model is then obtained that may be described as multi-localized, since it is composed of the local statistical models corresponding to the multiple points of the observed region.

The method is thus incremental and upgradeable. Indeed, each new recorded digital data or data stream makes it possible to update the statistical model. The statistical model represents the usual intrinsic appearance of the associated geographical region 300.

In an example, steps 101 to 111 of the first phase 100 are repeated until the operator considers that the knowledge base 313 is sufficiently complete to be able to be utilized in the second phase 200.

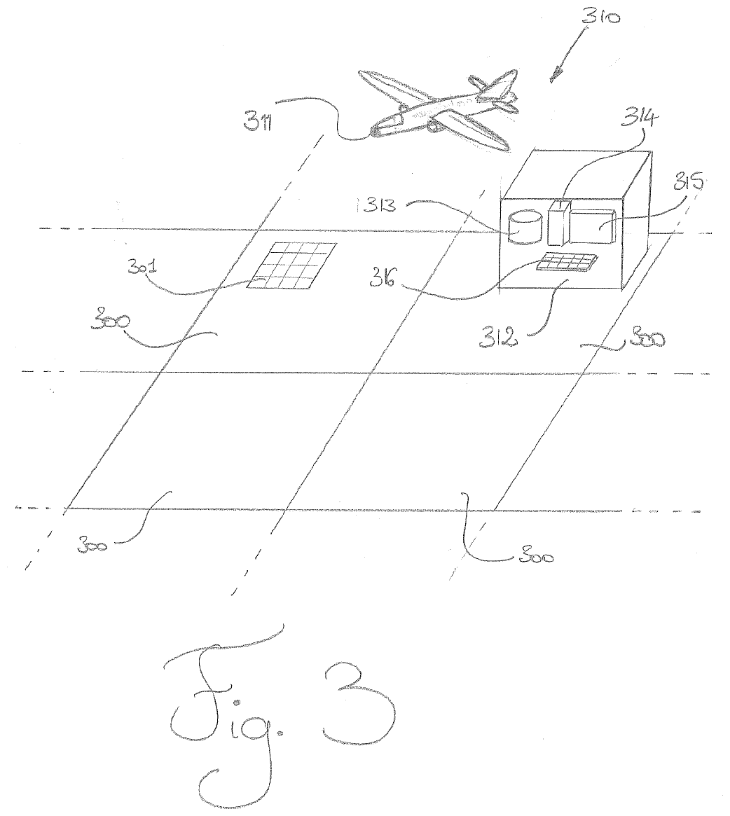

In FIG. 2, the second phase 200 comprises a step 201, in which the sensor 311 acquires a digital data stream corresponding to a geographical region 300 by the sensor 311. The second phase 200 thereafter comprises a step 202 of transmitting the digital data stream acquired in step 201 to the digital data processing center 312. The transmission step 202 is followed by a step 203 of processing the digital data stream transmitted in step 202 by the digital data processing center 312. This processing step 203 comprises eight steps 104-111.

The first two steps 201 and 202 of the second phase 200 are identical to the first two steps 101 and 102 of the first phase 100. Moreover, steps 104 to 110 of the first phase 100 are respectively identical to steps 204 to 210 of the second phase 200.

More precisely, in step 204, the digital data processing center 312 records the digital data stream transmitted in step 202.

In a step 205, the digital data processing center 312 determines the context of obtainment of the digital data stream recorded in step 204 of recording a digital data stream.

The second phase comprises, after step 205 of determining the context of obtainment, a step 206 of classifying the digital data stream recorded in step 204 as a function of the context of obtainment of the digital data stream. This digital data stream is then classed into one of the groups of digital data of the knowledge base 313, the group having the same context of obtainment as the context of obtainment of the digital data stream.

In a step 207, the processor 314 of the digital data processing center 312 determines statistical data on the digital data stream recorded in step 204.

The second phase 200 comprises, after step 210 of harmonizing compliance of the statistical data, step 211 of determining, via the processor 314, a degree of difference between the statistical data determined in the step 204 of determining statistical data and the statistical data of the statistical model of the group of data.

The step 211 of determining a degree of difference is followed by step 212 of comparing the degree of difference with a second predefined threshold. The second threshold is modifiable at any moment by the operator.

If the degree of difference is greater than the second threshold, an alert intended for the operator is generated in a step 213. This alert indicates that an anomaly or area of interest 301 has been detected and comprises the coordinates of the anomaly or area of interest 301 in a reference image of the geographical region 300 comprising the anomaly or area of interest 301. The alert is displayed on the display 315 of the digital data processing center 312.

In a step 214, the operator evaluates the relevance of the alert generated by virtue of the input device 316 of the digital data processing center 312. This interaction with the operator allows the operator to specialize the method as a function of what interests the operator. Indeed, if the operator indicates that the alert relating to the anomaly or area of interest 301 is not relevant, no alert relating to this type of anomaly or area of interest 301 is generated thereafter.

If the operator indicates that the alert relating to the anomaly or area of interest 301 is relevant and if the operator wishes to obtain additional information on the anomaly or area of interest 301, the operator manipulates the reference image of the geographical region 300 comprising the anomaly or area of interest 301 and performs searches in the knowledge base 313.

1. A method for analyzing recurrent streams of digital data of geographical regions to detect anomalies, comprising:
a first phase of learning an intrinsic appearance of each geographical region, in which a knowledge base comprising groups of digital data is generated;
a subsequent second phase of detecting anomalies in the geographical regions, the two phases comprising:
acquiring a digital data stream corresponding to a geographical region by a sensor of an explorer;
transmitting the digital data stream acquired to a digital data processing center by the explorer;
processing the digital data stream transmitted to the digital data processing center by:
recording the digital data stream transmitted to the digital data processing center to provide a recorded digital data stream;
determining a context of obtainment of the recorded digital data stream;
classifying the recorded digital data stream into a group of digital data of the knowledge base having a same context of obtainment as the context of obtainment determined for the recorded digital data stream, a set of the digital data of the group of digital data being represented by a statistical model;
determining a statistical data on the recorded digital data stream;
determining a degree of compatibility between the statistical data determined for the recorded digital data stream and a statistical data of the statistical model; and
comparing the degree of compatibility with a first predefined threshold;
wherein the first phase further comprises updating the statistical model in accordance with the statistical data determined for the recorded digital data stream during the first phase; and
wherein the second phase further comprises:
determining a degree of difference between the statistical data determined for the recorded digital data stream and the statistical model;
generating an alert in response to determination that the degree of difference between the statistical data determined for the recorded digital data stream and the statistical model is greater than a second predefined threshold; and
wherein the alert indicating the detection of an anomaly corresponding to a geographical region having an unusual appearance.

2. The method as claimed in claim 1, further comprises harmonizing compatibility of the recorded digital data stream with the digital data of the group of digital data of the knowledge base after comparing the degree of compatibility with the first predefined threshold

3. The method as claimed in claim 1, wherein in response to determination that the degree of compatibility is less than the predefined threshold, further comprises:
generating an alert indicating that automatically harmonizing compatibility of the group of digital data is not possible without an operator intervention;
manually harmonizing compatibility of the recorded digital data stream with the digital data of the group of digital data by the operator so that the computability of the group of digital data can be automatically harmonized; and
automatically harmonizing compatibility of the group of digital data.

4. The method as claimed in claim 1, wherein the context of obtainment of the recorded digital data comprises: a nature of the digital data stream, a geographical region corresponding to the digital data stream, a viewpoint of the sensor that recorded the digital data stream and a range of resolution of the digital data stream.

5. The method as claimed in claim 1, further comprises evaluating a relevance of the alert.

6. The method as claimed in claim 1, wherein the explorer is one of the following: a drone, a helicopter, a balloon, an airplane and a satellite.

7. The method as claimed in claim 1, wherein the sensor is one of the following: a camera, a photographic apparatus and a radar.

8. The method as claimed in claim 1, wherein the digital data processing center is remote from the explorer.

9. The method as claimed in claim 1, wherein the digital data processing center comprises a processor, a display and input device.
